(19) United States
(12) Patent Application Publication
(10) Pub. No.: US 2025/0007185 A1
(43) Pub. Date: Jan. 2, 2025

(54) BASE STATION ANTENNAS HAVING BEAM-SHAPING ELEMENTS THAT PRIMARILY SHAPE ANTENNA BEAMS IN ONLY ONE PLANE

(71) Applicant: Outdoor Wireless Networks LLC, Claremont, NC (US)

(72) Inventors: Haifeng Li, Allen, TX (US); Peter J. Bisiules, LaGrange Park, IL (US)

(21) Appl. No.: 18/757,692

(22) Filed: Jun. 28, 2024

Related U.S. Application Data
(60) Provisional application No. 63/511,409, filed on Jun. 30, 2023.

(51) Int. Cl. H01Q 25/00; H01Q 1/24; H01Q 3/34; H01Q 21/06; H04B 7/0426

(52) U.S. Cl. CPC H01Q 25/002; H01Q 3/34; H01Q 21/062; H01Q 1/246; H04B 7/043

(57) ABSTRACT

A base station antenna includes a radiating element configured to radiate in a first direction; and a beam-shaping element spaced apart from the radiating element in the first direction and offset from the radiating element in a second direction that is perpendicular to the first direction, such that the radiating element and the beam shaping element do not overlap in the first direction, the beam shaping element including a plurality of interdigitated fingers.

### CROSS-REFERENCE TO RELATED APPLICATION

The present application claims priority from and the benefit of U.S. Provisional Patent Application No. 63/511,409, filed Jun. 30, 2023, the disclosure of which is incorporated herein by reference in its entirety.

### FIELD OF THE INVENTION

The present invention generally relates to radio communications and, more particularly, to base station antenna systems that include multi-column antenna arrays.

### BACKGROUND

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three-sector configuration in which a cell is divided into three 120° “sectors” in the azimuth (horizontal) plane, A separate base station antenna provides coverage (service) to each sector. Typically, each base station antenna will include multiple vertically extending columns of radiating elements that operate, for example, using second generation (“2G”), third generation (“3G”), or fourth generation (“4G”) cellular network protocols. These vertically extending columns of radiating elements are typically referred to as “linear arrays,” and may be straight columns or columns in which some of the radiating elements are staggered horizontally. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each array to transmit and receive RF signals at two orthogonal polarizations.

Each of the above-described linear arrays is coupled to two ports of a radio, one port for each polarization. An RF signal that is to be transmitted by a linear array is passed from the radio to a port of the antenna. In the antenna, the RF signal is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Typically, these linear arrays will have remote electronic tilt (“RET”) capabilities, which allow a cellular operator to change the pointing angle of the generated antenna beams in the elevation (vertical) plane to change the size of the sector served by the linear array. Because the antenna beams generated by the above-described 2G/3G/4G linear arrays generate static antenna beams, they are often referred to as “passive” linear arrays.

Cellular operators are currently upgrading their networks to support fifth generation (“5G”)/New Radio (NR) cellular service. One important component of 5G cellular service is the use of so-called multi-column “active” beamforming arrays that operate in conjunction with active beamforming radios to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz and/or the 5.1-5.8 GHz frequency bands. Each column of radiating elements of such an active beamforming array is typically coupled to a respective port of a beamforming radio or to two ports if a dual polarized radiating elements are used. The beamforming radio may be a separate device or may be integrated with the active antenna array. The beamforming radio may adjust the amplitudes and phases of the sub-components of an RF signal that are output from each port of the radio to generate antenna beams that have narrowed beamwidths in the azimuth plane (and hence higher antenna gain). These narrowed antenna beams can be electronically steered in the azimuth plane by proper selection of the amplitudes and phases of the sub-components of an RF signal that are output from the beamforming radio.

To avoid having to increase the number of antennas at cell sites, the above-described 5G antennas also often include passive linear arrays that support legacy 2G, 3G and/or 4G cellular services. In some cases, both the active beamforming arrays and the passive linear arrays may be included in a single base station antenna. Another solution for providing an antenna that supports both 2G/3G/4G and 5G cellular service is to mount a 5G active antenna module (i.e., a module that includes an active beamforming array and associated beamforming radio) on the rear surface of a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. This design may be advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

According to some embodiments of the inventive concept, a base station antenna comprises: a radiating element configured to radiate in a first direction; and a beam-shaping element spaced apart from the radiating element in the first direction and offset from the radiating element in a second direction that is perpendicular to the first direction, such that the radiating element and the beam shaping element do not overlap in the first direction, the beam shaping element including a plurality of interdigitated fingers.

In other embodiments, the base station antenna further comprises: a plurality of beam-shaping elements spaced apart from the radiating element in the first direction and offset from the radiating element in the second direction that is perpendicular to the first direction, each of the plurality of beam-shaping elements including a plurality of interdigitated fingers, the plurality of beam shaping elements including the beam-shaping element and being arranged on a first side of the radiating element.

In still other embodiments, the plurality of beam-shaping elements is a first plurality of beam-shaping elements, the base station antenna further comprising: a second plurality of beam-shaping elements spaced apart from the radiating element in the first direction and offset from the radiating element in the second direction that is perpendicular to the first direction, each of the plurality of second beam-shaping elements including a plurality of interdigitated fingers, the second plurality of beam shaping elements being arranged on a second side of the radiating element opposite the first side.

In still other embodiments, the base station antenna further comprises: a plurality of beam-shaping elements spaced apart from the radiating element in the first direction without overlapping the radiating element in the first direction, each of the plurality of beam-shaping elements including a plurality of interdigitated fingers, the plurality of beam-shaping elements including the beam-shaping element and encircling the radiating element in a plan view.

In still other embodiments, the beam-shaping element comprises opposing first and second end portions each with the plurality of fingers extending therefrom, the plurality of fingers extending from the first end portion being interdigitated with the plurality of fingers extending from the second end portion.

In still other embodiments, the radiating element is configured to radiate at a frequency of 3.4-4.0 GHz; and a length of each of the plurality of fingers of the first and second end portions is less than ½ of a wavelength of a highest frequency.

In still other embodiments, the beam-shaping element comprises copper, aluminum, and/or metalized plastic.

In still other embodiments, the beam-shaping element is configured to modify a radiation pattern output from the radiating element in a first plane without modifying the radiation pattern output from the radiating element in a second plane.

In still other embodiments, the first plane is an azimuth plane and the second plane is an elevation plane.

In still other embodiments, the beam-shaping element is configured to increase a half-power beamwidth of the radiation pattern output from the radiating element in the azimuth plane.

In still other embodiments, the beam-shaping element is further configured to increase a gain of the radiating element.

In still other embodiments, the beam-shaping element is configured to re-direct radiation power associated with side lobes of a radiation pattern output from the radiating element towards a main lobe of the radiation pattern output from the radiating element.

In still other embodiments, the beam-shaping element is configured to increase a half-power beamwidth of the radiation pattern output from the radiating element in an azimuth plane.

According to some embodiments of the inventive concept a base station antenna comprises: an antenna array that includes multiple columns of radiating elements and having first and second opposing sides; a first plurality of beam-shaping elements positioned adjacent the first side; and a second plurality of beam-shaping elements positioned adjacent the second side; wherein at least some of the first plurality of beam-shaping elements and the second plurality of beam-shaping elements are configured to redirect RF energy emitted by the antenna array in a first plane without redirecting the RF energy emitted by the antenna array in a second plane.

In further embodiments, the first plane is an azimuth plane and the second plane is an elevation plane.

In still further embodiments, a first outer column of the multiple columns of radiating elements is adjacent the first side. The base station antenna further comprising: a third plurality of beam-shaping elements positioned between the first outer column and one of the multiple columns of radiating elements that is immediately adjacent to the first outer column; wherein at least some of the third plurality of beam-shaping elements are configured to redirect RF energy emitted by the antenna array in the first plane without redirecting the RF energy emitted by the antenna array in the second plane.

In still further embodiments, each of the first, second, and third pluralities of beam-shaping elements comprises opposing first and second end portions each with a plurality of fingers extending therefrom, the plurality of fingers extending from the first end portion being interdigitated with the plurality of fingers extending from the second end portion.

In still further embodiments, each of the radiating elements is configured to radiate at a frequency of 3.4-4.0 GHz; and a length of each of the plurality of fingers of the first and second end portions is less than ½ of a wavelength of a highest frequency.

In still further embodiments, each of the beam-shaping elements comprises copper, aluminum, and/or metalized plastic.

In still further embodiments, each of the first plurality of beam-shaping elements has a first orientation relative to the first outer column of the multiple columns of radiating elements; and each of the third plurality of beam-shaping elements has a second orientation relative to the first outer column of the multiple columns of radiating elements.

In still further embodiments, each of the multiple columns of radiating elements extends in a first direction; the plurality of fingers of ones of the first plurality of beam-shaping elements extends in a second direction perpendicular to the first direction; and the plurality of fingers of ones of the third plurality of beam-shaping elements extends in the first direction.

In some embodiments of the inventive concept, a base station antenna comprises: an antenna array that includes multiple columns of radiating elements and having first and second outer columns on opposing sides; and a plurality of beam-shaping elements positioned adjacent the first outer column that are configured to increase a half-power beamwidth of RF energy emitted by the first outer column.

In other embodiments, the plurality of beam-shaping elements is a first plurality of beam-shaping elements, the base station antenna further comprising: a second plurality of beam-shaping elements positioned adjacent the second outer column that are configured to increase a half-power beamwidth of RF energy emitted by the second outer column.

In still other embodiments, the first plurality of beam-shaping elements is further configured to increase the half-power beamwidth of the RF energy emitted by the first outer column in a first plane without modifying the beamwidth of the RF energy emitted by the first outer column in a second plane; and the second plurality of beam-shaping elements is further configured to increase the half-power beamwidth of the RF energy emitted by the second outer column in the first plane without modifying the beamwidth of the RF energy emitted by the second outer column in the second plane.

In still other embodiments, the first plane is an azimuth plane and the second plane is an elevation plane.

In still other embodiments, the plurality of beam-shaping elements is a first plurality of beam-shaping elements, the base station antenna further comprising: a second plurality of beam-shaping elements positioned between the first outer column and one of the multiple columns of radiating elements that is immediately adjacent to the first outer column, the second plurality of beam-shaping elements being configured to increase the half-power beamwidth of the RF energy emitted by the first outer column.

In still other embodiments, each of the first and second pluralities of beam-shaping elements comprises opposing first and second end portions each with a plurality of fingers extending therefrom, the plurality of fingers extending from the first end portion being interdigitated with the plurality of fingers extending from the second end portion.

In still other embodiments, each of the radiating elements is configured to radiate at a frequency of 3.4-4.0 GHz; and a length of each of the plurality of fingers of the first and second end portions is less than ½ of a wavelength of a highest frequency.

In still other embodiments, each of the beam-shaping elements comprises copper, aluminum, and/or metalized plastic.

In still other embodiments, each of the first plurality of beam-shaping elements has a first orientation relative to the first outer column of the multiple columns of radiating elements; and each of the second plurality of beam-shaping elements has a second orientation relative to the first outer column of the multiple columns of radiating elements.

In still other embodiments, each of the multiple columns of radiating elements extends in a first direction; the plurality of fingers of ones of the first plurality of beam-shaping elements extends in a second direction perpendicular to the first direction; and the plurality of fingers of ones of the second plurality of beam-shaping elements extends in the first direction.

Other devices, systems, and methods, according to embodiments of the inventive concept, will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE FIGURES

FIG. 1A is a schematic rear perspective view of a passive/active antenna system that comprises a passive base station antenna that has an active antenna module mounted thereon.

FIG. 1B is a schematic perspective view of the passive/active antenna system of FIG. 1A with a radome of the passive base station antenna removed.

FIG. 1C is a perspective view of the active antenna module of the passive/active antenna of FIGS. 1A-1B.

FIG. 2A is a perspective view of a radiating element and FIGS. 2B-2D are graphs that illustrate various characteristics of RF energy emitted by the radiating element of FIG. 2A.

FIG. 3 is a plan view of a beam-shaping element according to some embodiments of the inventive concept.

FIG. 4A is a perspective view of an antenna arrangement including a radiating element with a plurality of beam-shaping elements on sides of the radiating element and FIGS. 4B-4D are graphs that illustrate various characteristics of the RF energy emitted from the antenna arrangement of FIG. 4A according to some embodiments of the inventive concept.

FIG. 5A is a perspective view of an antenna arrangement including a radiating element with a plurality of beam-shaping elements encircling the radiating element in a plan view and FIGS. 5B-5D are graphs that illustrate various characteristics of the RF energy emitted from the antenna arrangement of FIG. 5A according to some embodiments of the inventive concept.

FIG. 6A is a perspective view of an antenna arrangement including a radiating element with a plurality of beam-shaping elements overlapping the radiating element in a plan view and FIGS. 6B-6D are graphs that illustrate various characteristics of the RF energy emitted from the antenna arrangement of FIG. 6A according to some embodiments of the inventive concept.

FIGS. 7A and 7B are radiation patterns of an antenna without a beam-shaping element and with a beam-shaping element, respectively, according to some embodiments of the inventive concept.

FIGS. 8A and 8B are radiation patterns of an antenna without a beam-shaping element and with a beam-shaping element, respectively, according to some embodiments of the inventive concept.

FIG. 9 is a perspective view of a multi-column radiating element antenna including multiple beam-shaping elements according to some embodiments of the inventive concept.

FIGS. 10 and 11 are block diagrams of arrangements of radiating element columns and beam-shaping elements in an antenna according to some embodiments of the inventive concept.

### DETAILED DESCRIPTION

In the following detailed description, numerous specific details are set forth to provide a thorough understanding of embodiments of the inventive concept. However, it will be understood by those skilled in the art that embodiments of the inventive concept may be practiced without these specific details. In some instances, well-known methods, procedures, components, and circuits have not been described in detail so as not to obscure the inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination

Some embodiments of the inventive concept stem from a realization that in a multi-column radiating element array in a directional antenna, the radiating elements in the outer columns may perform differently than the radiating elements in the interior columns. This is due, at least in part, to the outer columns of the array having an adjacent column on only one side thereof. A radiating element may generate a radiation pattern with an increased main lobe azimuth beamwidth due to phase alignment and/or mutual coupling of signals generated by radiating elements in adjacent columns of the array. Specifically, some of the RF radiation that is emitted by a first interior column of the array will couple to the adjacent columns, and the RF energy is re-radiated from the radiating elements in the adjacent columns. This may act to increase the azimuth beamwidth of the antenna beam generated by the first interior column because the phasing of the RF energy emitted by the first interior column and the RF energy that is re-radiated from the two adjacent columns may act to broaden the azimuth beamwidth of the generated antenna beam. This can result in the antenna beams generated by the multi-column array having reduced gain, particularly when the antenna beams are electronically scanned to large scanning angles in the azimuth plane.

The problem of the antenna beams generated by a multi-column array having lower gain at large electronic scanning angles may be further exacerbated when the multi-column array is used in a passive/active antenna system. In particular, the reflector assembly of the passive base station antenna of a passive/active antenna system (herein also referred to as the “passive reflector assembly”) may include a large opening that allows RF energy from the multi-column beamforming array that is included in the active antenna module to transmit and receive RF signals through the passive base station antenna. First and second longitudinally extending reflector strips may be provided on either side of this opening and radiating elements of the 2G/3G/4G arrays of the passive antenna may be mounted on the reflector strips of the passive reflector assembly. These reflector strips, however, may partially block RF radiation emitted by the outer columns of the multi-column beamforming array, further reducing the gain of the antenna beams generated by multi-column array, with the reduction being the highest when the antenna beams are electronically scanned to large scanning angles in the azimuth plane. In addition, an antenna module may include a frequency selective surface that is positioned such that the RF radiation emitted by middle columns of a multi-column array is generally perpendicular to the frequency selective surface allowing the radiation to pass through. The RF radiation output from end columns of a multi-column array may not be perpendicular to the frequency selective surface, which can result in the frequency selective surface blocking some of the RF radiation resulting in a loss of up to 10 dB.

Some embodiments of the inventive concept may provide one or more beam-shaping elements that may be placed in front of radiating elements in an antenna array. These beam-shaping elements may redirect energy emitted by the radiating elements that is associated with side lobes of a radiating pattern towards a main lobe of the radiation pattern to increase the half-power beamwidth of the radiation pattern in the azimuth plane. Moreover, the one or more beam-shaping elements may be configured to modify the radiation pattern output from the radiating elements in the azimuth plane without modifying the radiation pattern output from the radiating elements in the elevation plane. Thus, in some embodiments, such as antennas that include a multi-column array of radiating elements, one or more beam-shaping elements may be arranged adjacent to the end columns of radiating elements, i.e., the columns having an adjacent column of radiating elements on only one side, to increase half-power beamwidth of the radiation patterns output from the end columns. These beam-shaping elements may at least partially compensate for the lack of an adjacent column on one side of an outer column in a multi-column array. As a beam-shaping element may reduce the gain of a radiating element when placed in a position that overlaps a radiating element in a signal transmission direction, the beam-shaping element may be arranged in an offset location perpendicular to the signal transmission direction to reduce the amount of overlap with the radiating element in the signal transmission direction. This may balance the beamwidth widening effect on the radiation pattern output from a radiating element with reduction in signal transmission gain. Although embodiments of the inventive concept are described herein with respect to the beam-shaping element operating in a base station antenna configured to transmit and receive in the 3.4-4.0 GHz frequency band, the embodiments may also be applicable to higher frequency band systems, such as those that operate at frequencies greater than 6 GHz. In such embodiments, the beam-shaping element may be made with pure sheet metal at an increased size, which my reduce manufacturing errors.

Example embodiments of the inventive concept will now be discussed in further detail with reference to the drawings.

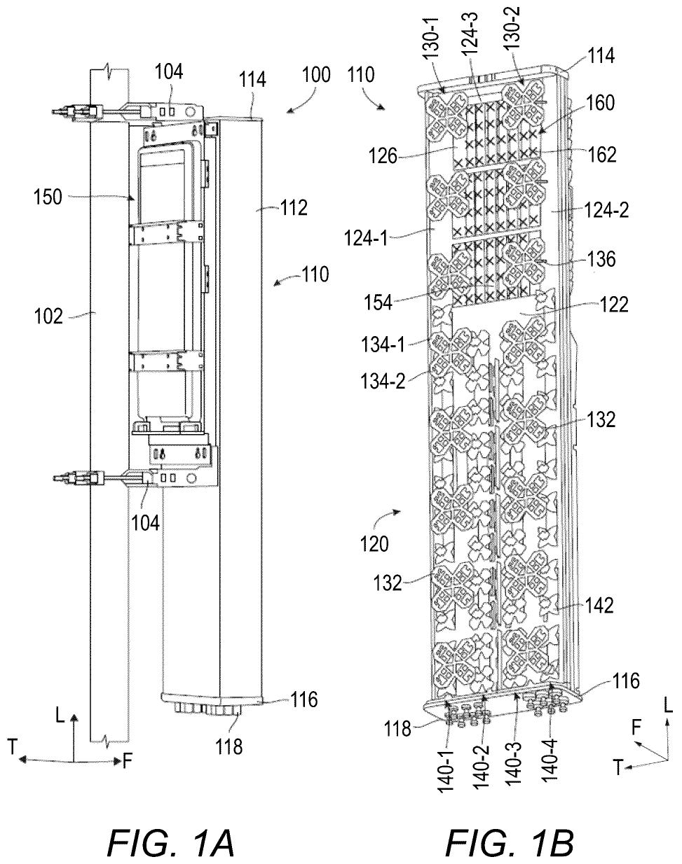

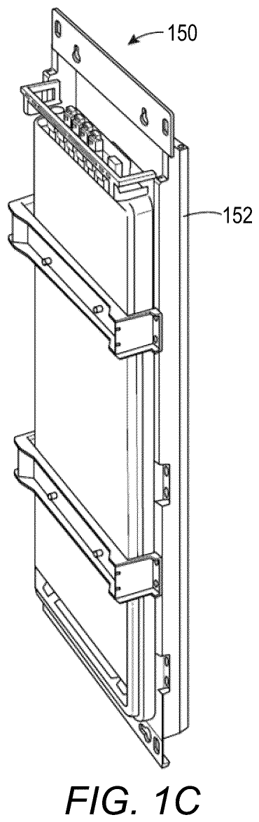

FIGS. 1A-1C illustrate a passive/active antenna system 100 that includes both a passive base station antenna 110 and an active antenna module 150. In particular, FIG. 1A is a schematic rear perspective view of the conventional passive/active antenna system 100. FIG. 1B is a schematic perspective view of the passive/active antenna system 100 of FIG. 1A with a radome of the passive base station antenna 110 omitted. FIG. 1C is a perspective view of the active antenna module 150. In FIGS. 1A and 1B, the axes illustrate the longitudinal (L), transverse (T) and forward (F) directions of the base station antenna system 100.

Referring to FIG. 1A, the passive/active antenna system 100 may be mounted, for example, on an antenna tower 102 using mounting hardware 104. The passive/active antenna system 100 includes the passive base station antenna 110 and the active antenna module 150 that is mounted behind the passive base station antenna 110. The active antenna module 150. The active antenna module 150 may be mounted directly on a rear surface of the passive base station antenna 110 or may be held in place behind the passive base station antenna 110 by the mounting hardware 104 that is used to mount the passive/active antenna system 100 on the antenna tower 102 (or other structure). The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module, preferably without removing the passive base station antenna 110 from the antenna tower 102.

Referring to FIG. 1B, the passive base station antenna 110 includes a reflector assembly 120. The reflector assembly 120 may be referred to herein as a “passive reflector assembly” since it is part of the passive base station antenna 110. The passive reflector assembly 120 includes a main reflector 122 and spaced-apart first and second reflector strips 124-1, 124-2 that extend longitudinally from respective first and second opposed sides of the main reflector 122. The passive reflector assembly 120 may further include a third reflector strip 124-3 that extends in a transverse direction between the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3.

The passive base station antenna 110 further includes a plurality of passive linear arrays of radiating elements that extend forwardly from the passive reflector assembly 120. The linear arrays may support, for example, 2G, 3G and/or 4G cellular service. In the example passive base station antenna 110 shown in FIGS. 1A-1B, the linear arrays include first and second low-band linear arrays 130-1, 130-2 that are configured to operate in all or part of the 617-960 MHz frequency band. Each low-band linear array 130 comprises a vertically extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically extending column of mid-band radiating elements 142. Each of the low-band and mid-band linear arrays 130, 140 may generate relatively static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in one of the linear arrays, and the second RF port 118 is connected between a second port of a radio and the second polarization radiators of the radiating elements in the linear array. RF signals that are to be transmitted by a selected one of the linear arrays 130, 140 are passed from the radio to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

Most of the low-band and mid-band radiating elements 132, 142 are mounted to extend forwardly from the main reflector 122. However, low-band linear arrays 130-1, 130-2 extend substantially the full length of the passive/active antenna system 100 and hence extend beyond the main reflector 122. The first and second reflector strips 124-1, 124-2 provide mounting locations for low band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may improve the performance of the low-band linear arrays 130-1, 130-2.

Each low-band radiating element 132 may comprise a slant −45°/+45° cross-dipole radiating element that includes a −45° dipole radiator 134-1 and a +45° dipole radiator 134-2 that are arranged to form a cross when the radiating element 132 is viewed from the front. The dipole radiators 134-1, 134-2 may be mounted on a feed stalk 136 of the radiating element 132. Conventionally, cross-dipole radiating elements extend forwardly from a main reflector surface of a reflector assembly with the feed stalks the radiating elements extending perpendicularly to the main reflector surface. The feed stalk may be configured to pass RF signals between the dipole radiators and an associated feed network and may also be used to support the dipole radiators forwardly of the reflector assembly. The radiating elements 132 that extend forwardly from the main reflector 122 may have a conventional design where the feed stalks extend perpendicularly to the main reflector 122. However, the centers of the low band radiating elements 132 that are mounted on the first and second reflector strips 124-1, 124-2 are above the opening 126, and hence conventional radiating elements cannot be readily used. Thus, the three uppermost low band radiating elements 132 have so-called “tilted” feed stalks 136 that extend forwardly from the reflector strips 124-1, 124-2 at oblique angles. In particular, the base of each feed stalk 136 is mounted on one of the reflector strips 124-1, 124-2, and the feed stalk 136 extends at an angle so that the center of the cross defined by the dipole radiators 134-1, 134-2 is above the opening 126. In example embodiments, the feed stalks 136 may extend at an angle of about 300-60° with respect to the front surface of the reflector strips 124-1, 124-2.

Referring to FIGS. 1B and 1C, the active antenna module 150 includes a multi-column beamforming array 160 of radiating elements 162 and a beamforming radio (not visible in the figures). The multi-column beamforming array 160 may be mounted in a forward portion of a radome 152 of the active antenna module 150, and the beamforming radio may be mounted behind the multi-column beamforming array 160. The beamforming array 160 may, for example, comprise a plurality of vertically extending columns of high band radiating elements 162 that are configured to operate in all or part of the 3.1-4.2 GHz frequency band. The high band radiating elements 162 are mounted to extend forwardly from a reflector 154 of the active antenna module 150 (herein the “active reflector”). The beamforming radio is capable of electronically adjusting the amplitude and/or phase of the subcomponents of an RF signal that are output to different radiating elements 162 of the multi-column beamforming array 160. For example, each port of the beamforming radio may be coupled to a column of radiating elements of the beamforming array 160, and the amplitudes and phases of the sub-components of the RF signals that are fed to each column may be adjusted so that the generated antenna beams are narrowed in the azimuth plane and pointed in a desired direction in the azimuth plane.

As is shown in FIG. 1B, the beamforming array 160 of active antenna module 150 is mounted behind the opening 126 in the passive reflector assembly 114. The beamforming array 160 is visible in FIG. 1B as the radomes 112, 152 of both the passive base station antenna 110 and the active antenna module 150 are removed in the view of FIG. 1B. The opening 126 in the passive reflector assembly 120 allows the antenna beams generated by the beamforming array 160 to pass through the passive base station antenna 110 and out of the front of the radome 112 of the passive base station antenna 110 to provide service to the coverage area of the passive/active antenna system 100.

A frequency selective surface (“FSS”) may be positioned in the opening 126. The FSS may be coplanar with the opening 126, in front of the opening 126 or behind the opening 126. The FSS can have a grid pattern such as a grid pattern of metal patches and/or other metal structures. The metal patches/structures may be arranged in one or more layers. In some embodiments, the FSS may be formed on a substrate such as, for example, a printed circuit board. In other embodiments, the FSS may be formed in sheet metal. In some embodiments, the opening 126 may comprise an FSS that is formed in the metal sheet of the passive reflector assembly 122. The FSS may be configured to allow RF energy emitted by the high band radiating elements 162 in the beamforming array 160 to pass therethrough, while the FSS reflects RF energy in lower frequency bands (and specifically, low-band RF signals that are emitted by the low-band radiating elements 132. The grid pattern can be arranged in any suitable manner and may be symmetric or asymmetric across a width and/or length of the FSS. The grid pattern may comprise sub-wavelength periodic microstructures.

In many applications the beamforming array 160 may need to scan the generated antenna beams to very wide angles in the azimuth plane, such as angles of 50° or more. When the peak of the antenna beam generated by the beamforming array 160 is scanned to a large electronic scanning angle, the antenna beam is pointed more toward one of the two sides of the passive reflector assembly, which tends to increase the amount of the RF radiation that is directed toward the longitudinally extending reflector strip 124 on that side of the antenna. Since the reflector strip 124 is formed of metal, the RF radiation that impinges on the reflector strip 124 is typically reflected backwardly, which acts to decrease the gain of the antenna beam, and which may also result in further reflections that can cause destructive cancellation, further degrading performance. The reflector strip 124 will primarily reflect the RF radiation emitted by the outer columns of the beamforming array 160 that are closest to the reflector strip 124 on the side of the passive reflector assembly 120 to which the antenna beam is being electronically scanned.

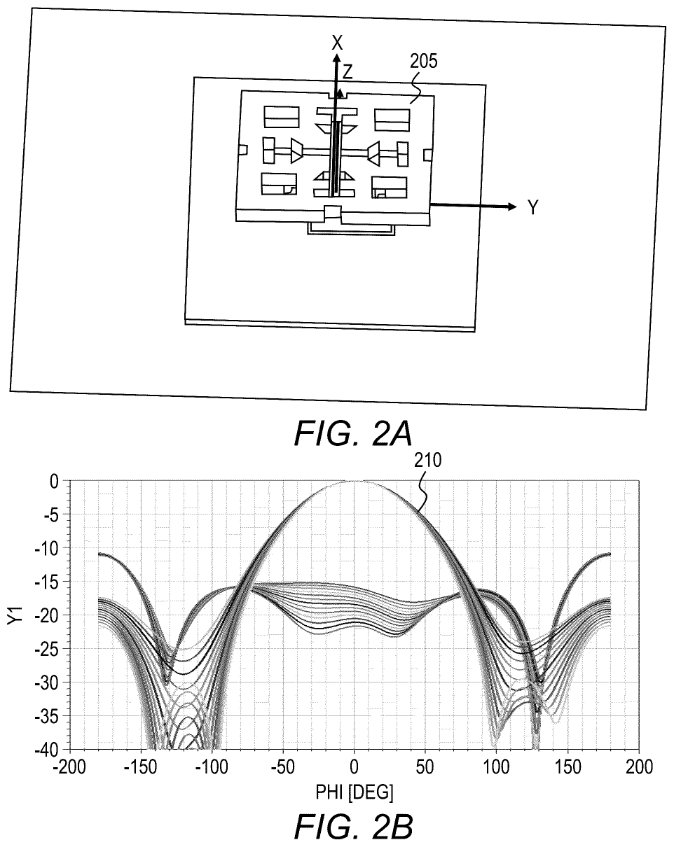

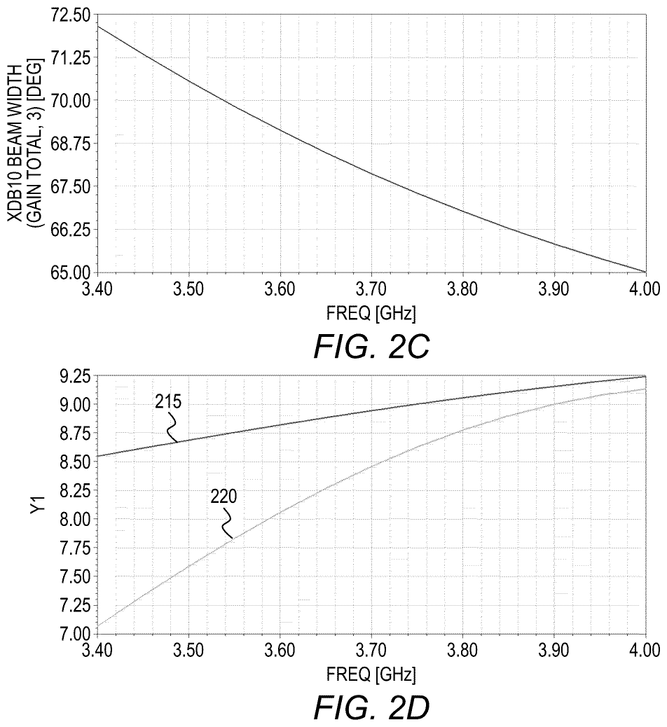

Referring to FIGS. 2A-2D, a radiating element 205 is shown in FIG. 2A that may be used in a base station array according to some embodiments of the inventive concept. The radiating element 205 may, for example, be representative of radiating elements used in multiple columns of an antenna array. A radiation pattern in the azimuth plane of the radiating element 205 is shown in FIG. 2B including a main lobe 210 and multiple side lobes. As shown in FIG. 2C, the radiating element 205 has an average beamwidth of 68 degrees across a frequency range of 3.4 GHz-4.0 GHz. The directivity curve 215 of FIG. 2D shows an average directivity of 8.9 dB across the frequency range of 3.4 GHz-4.0 GHz for the radiating element 205 and the gain curve 220 shows an average gain of 8.3 dB across the frequency range of 3.4 GHz-4.0 GHz for the radiating element 205. As used herein, directivity is gain plus insertion loss.

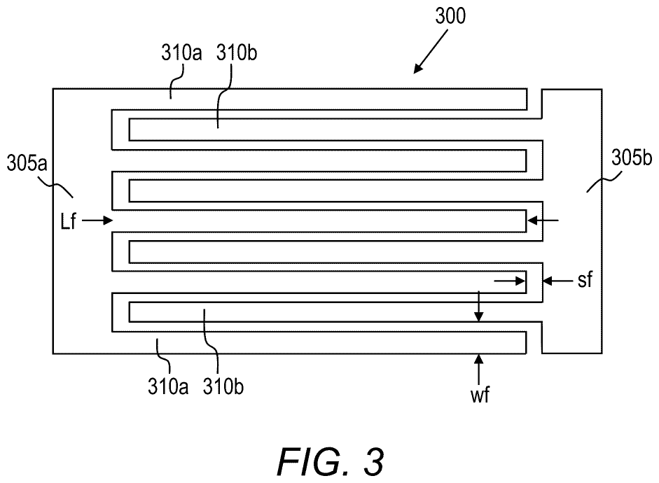

FIG. 3 is a plan view of a beam-shaping element 300 according to some embodiments of the inventive concept. As described above, one or more beam-shaping elements 300 may be used to increase the 3 dB or half-power beamwidth of the radiation pattern output by a radiating element according to some embodiments of the inventive concept. Moreover, the beam-shaping element(s) 300 may increase the half-power beamwidth in the azimuth plane without modifying the radiation pattern in elevation plane. As shown in FIG. 3, a beam-shaping element 300 includes two opposing end portions 305a and 305b with first and second pluralities of fingers 310a and 310b extending therefrom, respectively. Each of the plurality of fingers 310a, 310b may have a length Lf=α*λ where λ is the wavelength of the signal transmitted by one or more associated radiating elements. Each of the plurality of fingers 310a, 310b may further have a width of Wf=β*λ, where λ is the wavelength corresponding to the center frequency of the operating frequency band of the high-band radiating elements 162. The spacing between ends of the plurality of fingers 310a, 310b and the end portions 305a, 305b is given by Sf=ρ*λ, where λ is the wavelength corresponding to the center frequency of the operating frequency band of the high-band radiating elements 162. For frequencies in the 3.4 GHz-4.0 GHz range, typical values of α may be less than ½. That is, the finger length may be less than ½ have a wavelength of the highest frequency. Example values for β, and ρ may vary based on the coupling level desired. The beam-shaping element 300 may be viewed as a parasitic element comprising a partially reflective surface that is configured to provide lens-like functionality to re-direct RF energy from one portion of a radiation pattern to another portion of the radiation pattern. Specifically, the beam-shaping element 300 may be placed adjacent to a radiating element to re-direct RF energy from side lobes of the radiation pattern to the main lobe to widen the beamwidth of the main lobe in the azimuth plane without modifying the beamwidth in the elevation plane. The length of the fingers, width of the fingers, and/or spacing between the fingers may be adjusted so that the impedance of the beam-shaping element is greater than about 50 Ohms. The beam shaping element may be made of a variety of different materials including, but not limited to, copper, aluminum, and/or metalized plastic.

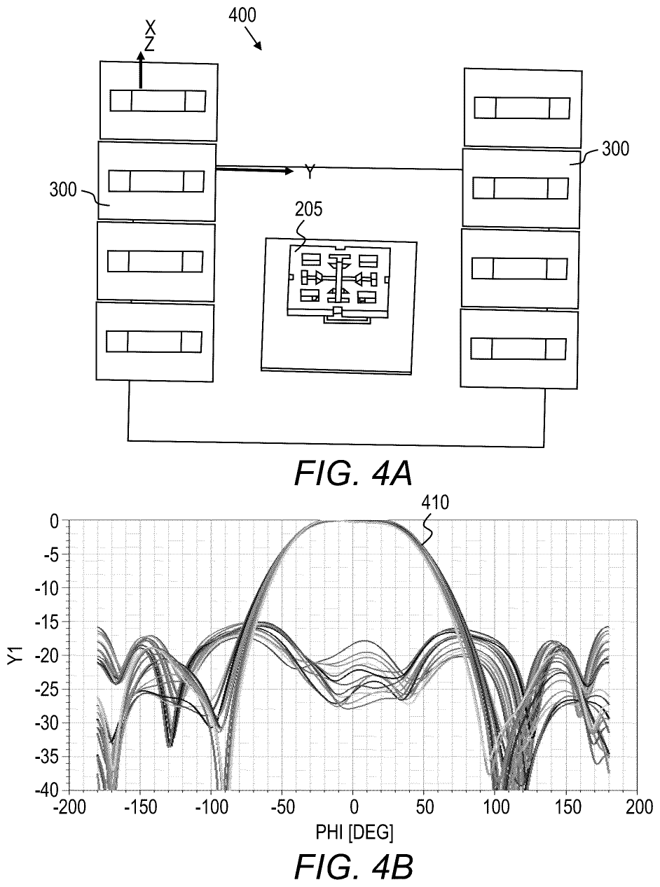

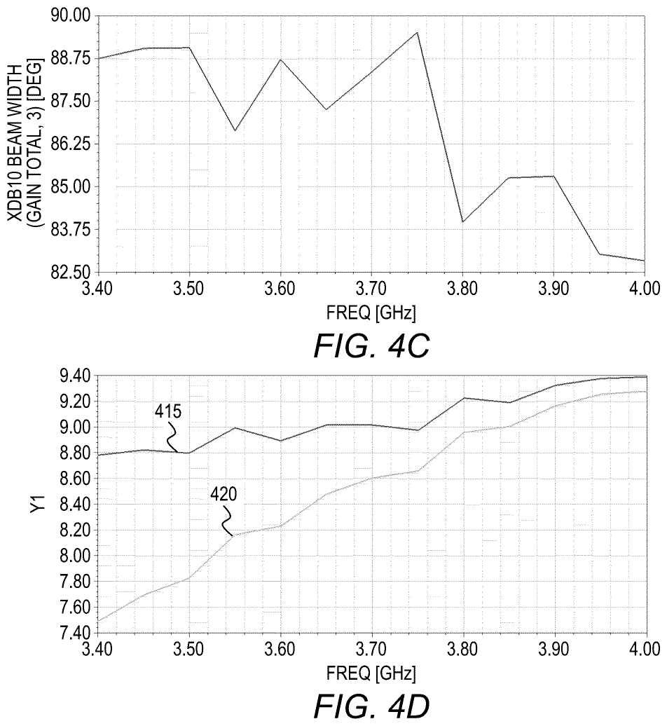

FIG. 4A is a perspective view of an antenna arrangement including a radiating element 205 with a plurality of beam-shaping elements 300 on sides of the radiating element and FIGS. 4B-4D are graphs that illustrate various characteristics of the RF energy emitted from the antenna arrangement of FIG. 4A according to some embodiments of the inventive concept. In the example shown in FIG. 4A, an antenna assembly 400 includes a radiating element 205 and is further configured with two columns of beam-shaping elements 300 positioned in front of the radiating element 205, i.e., spaced apart from the radiating element 205 in a direction corresponding to a signal transmission direction of the radiating element 205. In the example shown in FIG. 4A, the signal transmission direction is perpendicular to an outer surface of the radiating element 205 when viewed in a plan view. For example, the radiating element 205 extends forward from a reflector and the signal transmission direction is perpendicular to the reflector. The two columns of beam-shaping elements 300 are further offset from the radiating element in a lateral direction, i.e., perpendicular to the signal transmission direction of the radiating element 205, so that the beam shaping elements 300 do not overlap the radiating element 205 in the signal transmission direction. A radiation pattern in the azimuth plane of the antenna assembly 400 is shown in FIG. 4B including a main lobe 410 and multiple side lobes. As shown in FIG. 4C, the antenna assembly 400 has an average beamwidth of 87 degrees across a frequency range of 3.4 GHz-4.0 GHz. The directivity curve 415 of FIG. 4D shows an average directivity of 9.1 dB across the frequency range of 3.4 GHz-4.0 GHz for the antenna assembly 400 and the gain curve 420 shows an average gain of 8.5 dB across the frequency range of 3.4 GHz-4.0 GHz for the antenna assembly 400. Thus, relative to the example of FIGS. 2A-2D, the beam-shaping elements 300 increase or widen the average half-power bandwidth in the azimuth plane from 68 degrees to 87 degrees while increasing directivity and decreasing loss.

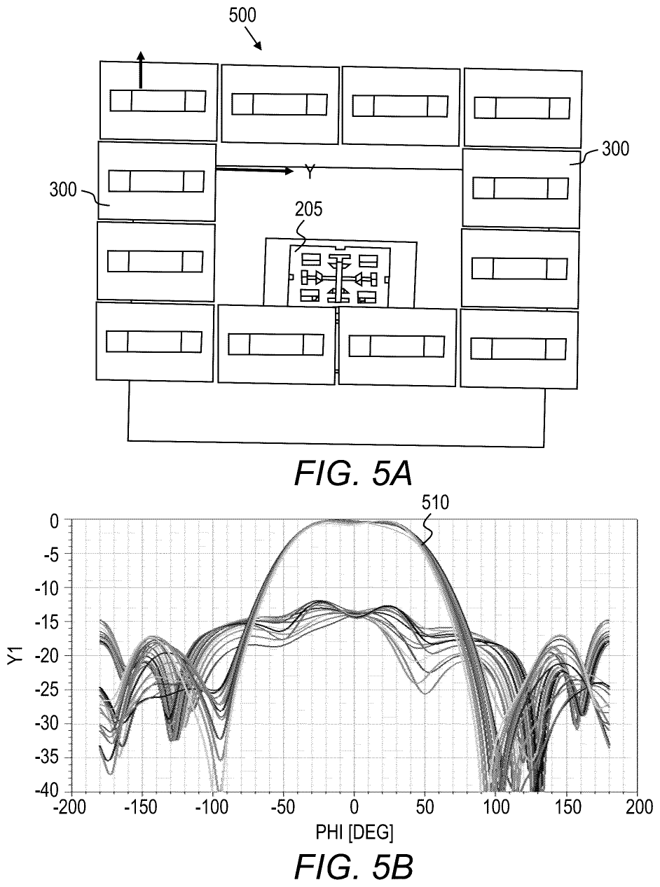

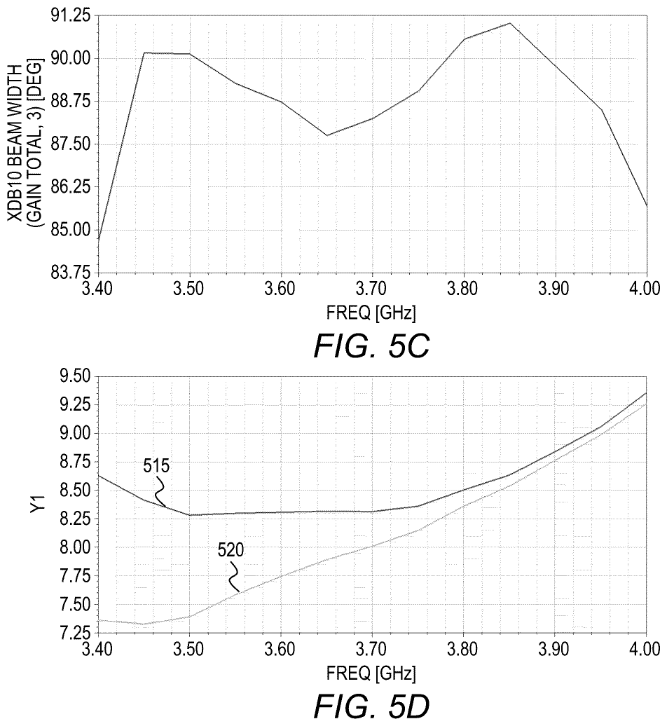

FIG. 5A is a perspective view of an antenna arrangement including a radiating element 205 with a plurality of beam-shaping elements 300 encircling the radiating element in a plan view and FIGS. 5B-5D are graphs that illustrate various characteristics of the RF energy emitted from the antenna arrangement of FIG. 5A according to some embodiments of the inventive concept. In the example shown in FIG. 5A, an antenna assembly 500 includes a radiating element 205 and is further configured with a plurality of beam-shaping elements 300 positioned in front of the radiating element 205, i.e., spaced apart from the radiating element 205 in a direction corresponding to a signal transmission direction of the radiating element 205. In the example shown in FIG. 5A, the signal transmission direction is perpendicular to an outer surface of the radiating element 205 when viewed in a plan view. For example, the radiating element 205 extends forward from a reflector and the signal transmission direction is perpendicular to the reflector. The plurality of beam-shaping elements 300 are further offset from the radiating element in lateral directions, i.e., perpendicular to the signal transmission direction of the radiating element 205, so that the beam shaping elements 300 do not overlap the radiating element 205 in the signal transmission direction, but instead encircle the radiating element in a plan view. A radiation pattern of the antenna assembly 500 is shown in FIG. 5B including a main lobe 510 and multiple side lobes. As shown in FIG. 5C, the antenna assembly 500 has an average beamwidth of 88 degrees across a frequency range of 3.4 GHz-4.0 GHz. The directivity curve 515 of FIG. 5D shows an average directivity of 8.5 dB across the frequency range of 3.4 GHz-4.0 GHz for the antenna assembly 500 and the gain curve 520 shows an average gain of 8.1 dB across the frequency range of 3.4 GHz-4.0 GHz for the antenna assembly 500. Thus, relative to the example of FIGS. 2A-2D, the beam-shaping elements 300 increase or widen the average half-power bandwidth in the azimuth plane from 68 degrees to 88 degrees. But the arrangement in which the beam-shaping elements 300 encircle the radiating element 205 decreases the gain resulting in reduced directivity and gain relative to the example of FIGS. 2A-2D in which beam-shaping elements 300 are not used and relative to the example of FIGS. 4A-4D in which the beam-shaping elements 300 are only on two sides of the radiating element 205.

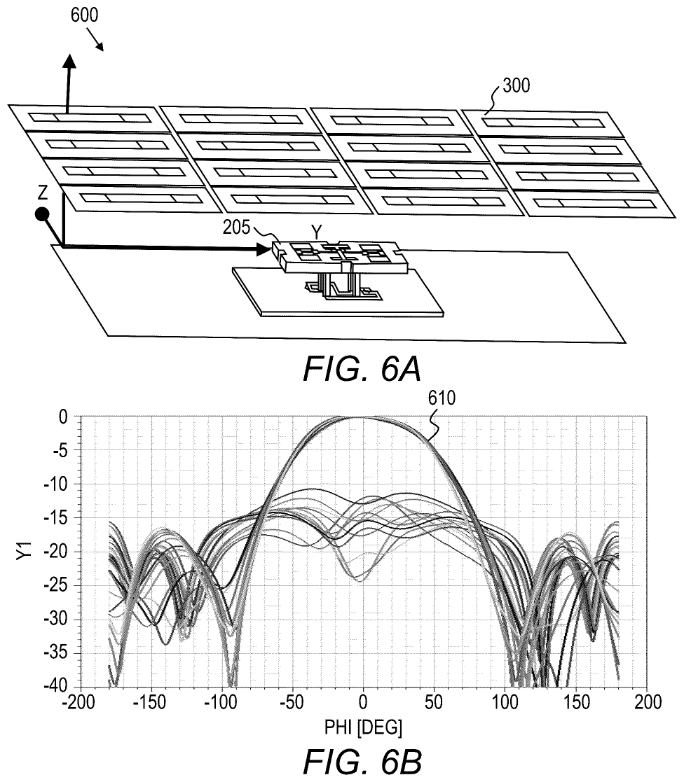

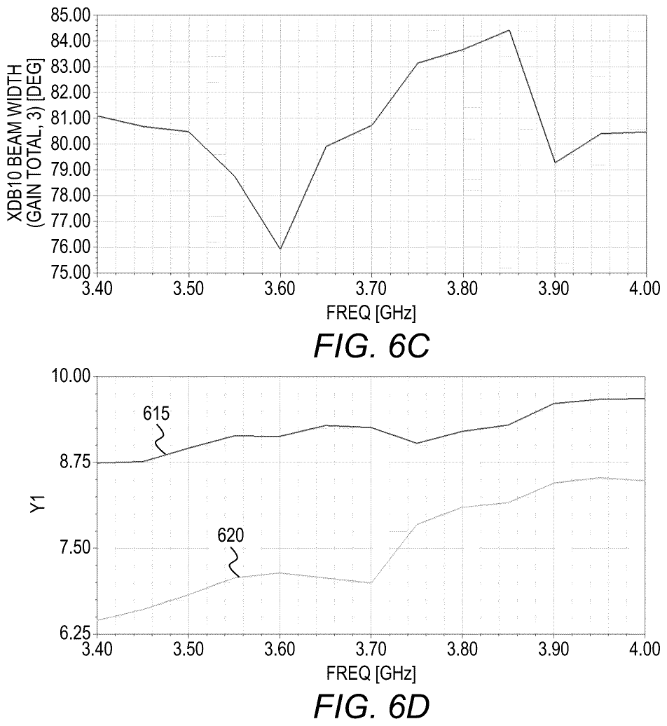

FIG. 6A is a perspective view of an antenna arrangement including a radiating element 205 with a plurality of beam-shaping elements 300 overlapping and encircling the radiating element in a plan view, and FIGS. 6B-6D are graphs that illustrate various characteristics of the RF energy emitted from the antenna arrangement of FIG. 6A according to some embodiments of the inventive concept. In the example shown in FIG. 6A, an antenna assembly 600 includes a radiating element 205 and is further configured with a plurality of beam-shaping elements 300 positioned in front of the radiating element 205, i.e., spaced apart from the radiating element 205 in a direction corresponding to a signal transmission direction of the radiating element 205. For example, the radiating element 205 extends forward from a reflector and the signal transmission direction is perpendicular to the reflector. In the example shown in FIG. 6A, the signal transmission direction is perpendicular to an outer surface of the radiating element 205 when viewed in a plan view. The plurality of beam-shaping elements 300 are further offset from the radiating element in lateral directions, i.e., perpendicular to the signal transmission direction of the radiating element 205, and also overlaps the radiating element 205 in the signal transmission direction. A radiation pattern of the antenna assembly 600 is shown in FIG. 6B including a main lobe 610 and multiple side lobes. As shown in FIG. 6C, the antenna assembly 600 has an average half-power beamwidth in the azimuth plane of 81 degrees across a frequency range of 3.4 GHz-4.0 GHz. The directivity curve 615 of FIG. 6D shows an average directivity of 9.2 dB across the frequency range of 3.4 GHz-4.0 GHz for the antenna assembly 600 and the gain curve 620 shows an average gain of 7.5 dB across the frequency range of 3.4 GHz-4.0 GHz for the antenna assembly 600. Thus, relative to the example of FIGS. 2A-2D, the beam-shaping elements 300 increase or widen the average half-power bandwidth in the azimuth plane from 68 degrees to 81 degrees. The arrangement of FIG. 6A in which the beam-shaping elements 300 encircle and overlap the radiating element 205 increases the insertion loss resulting in higher directivity relative to the example of FIGS. 2A-2D in which beam-shaping elements 300 are not used, relative to the example of FIGS. 4A-4D in which the beam-shaping elements 300 are only on two sides of the radiating element 205, and relative to the example of FIGS. 5A-5D in which the beam-shaping elements 300 encircle, but do not overlap the radiating element 205. But the arrangement of FIG. 6A reduces the gain relative to the examples of FIGS. 2A-2D, 4A-4D, and 5A-5D due to the overlap of the beam-shaping elements 300 in the signal transmission direction of the radiating element 205. The higher directivity is due to the increased insertion loss as directivity given by a sum of the gain plus the insertion loss.

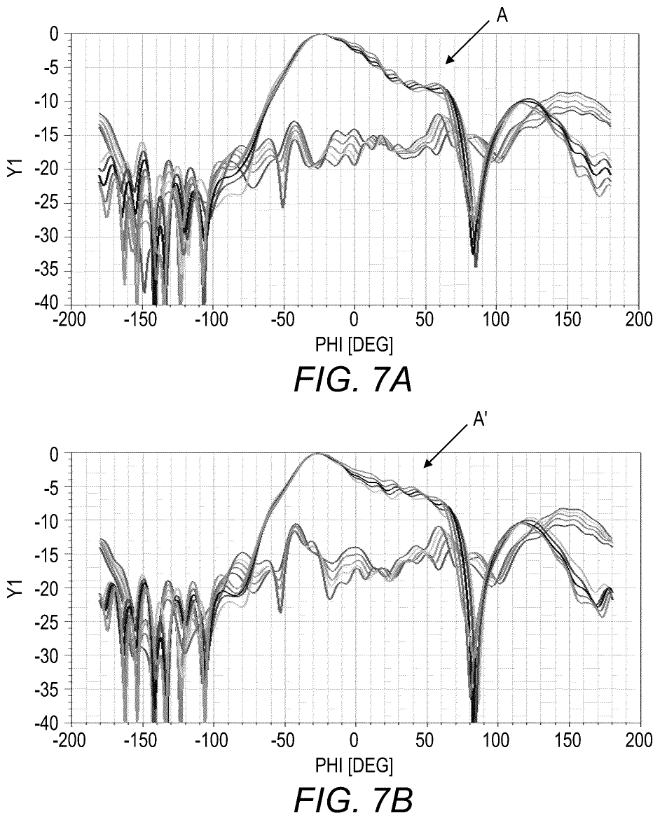

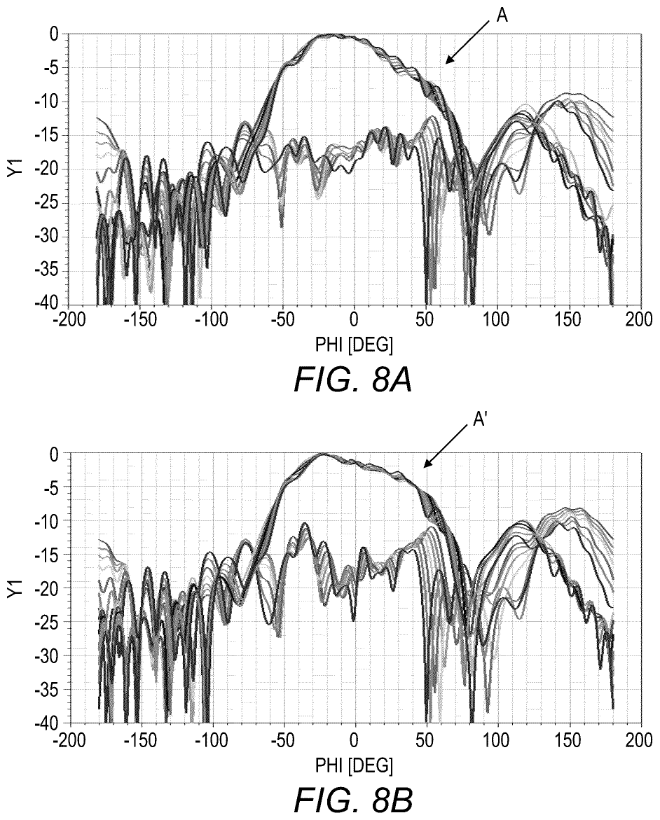

FIGS. 7A and 7B and FIGS. 8A and 8B are each two example radiation patterns of an antenna without a beam-shaping element and with a beam-shaping element, respectively, according to some embodiments of the inventive concept. Specifically, the radiation patterns are for an outer column of an antenna array that includes multiple columns of radiating elements. The two radiation patterns of FIGS. 7A and 8A correspond to an outer column of an antenna array without the use of any beam-shaping element(s) 300. The two radiation patterns 7B and 8B correspond to the outer column of the antenna array with the use of beam-shaping elements 300. Comparing the half-power beamwidths of the radiation patterns of 7A and 8A with half-power beamwidths of the radiation patterns of 7B and 8B, it can be seen that the beam-shaping elements 300 re-direct RF energy from the side-lobes into the main lobe. Specifically, the beam-shaping elements re-direct the RF energy in the region A of FIGS. 7A and 8A to increase the energy in the main lobe as shown in region A′ in FIGS. 7B and 8B.

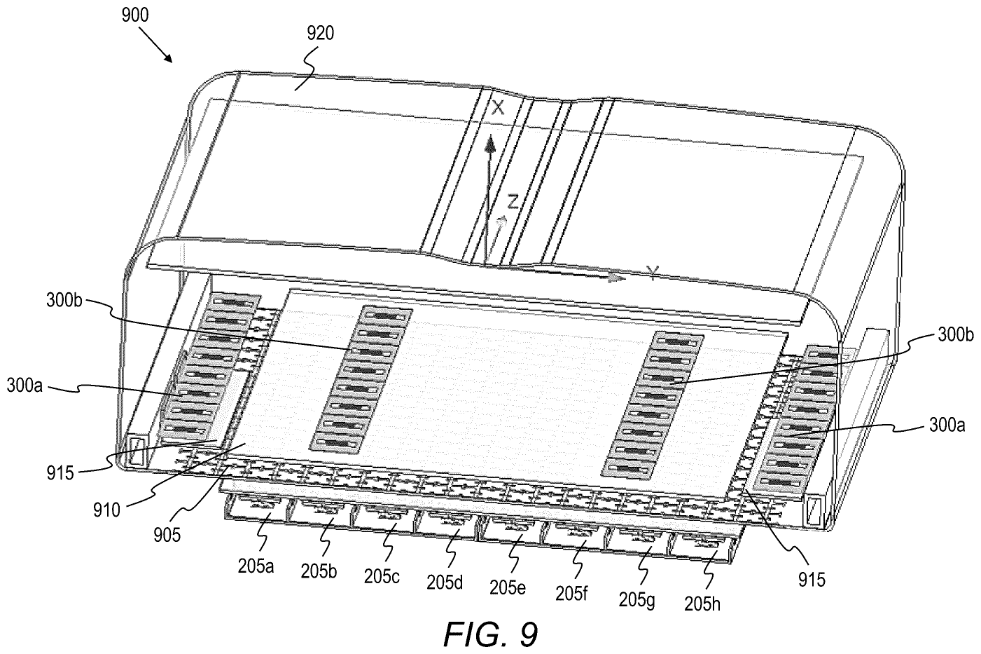

FIG. 9 is a perspective view of a multi-column radiating element antenna 900 including multiple beam-shaping elements according to some embodiments of the inventive concept. Referring to FIG. 9, the antenna 900 includes eight columns of radiating elements 205a, 205b, 205c, 205d, 205e, 205f, 205g, and 205h. Each column 205a, . . . 205h includes a plurality of radiating elements 205, which are configured to radiate in the X direction as shown in FIG. 9. A FSS 905 may be placed in front of the columns of radiating elements 205a, . . . 205h. As described above, the FSS 905 can have a grid pattern, such as a grid pattern of metal patches and/or other metal structures. The metal patches/structures may be arranged in one or more layers. In some embodiments, the FSS 905 may be formed on a substrate such as, for example, a printed circuit board. In other embodiments, the FSS may be formed in sheet metal. The FSS 905 may be configured to allow RF energy emitted by high band radiating elements to pass therethrough, while the FSS 905 reflects RF energy in lower frequency bands. The grid pattern can be arranged in any suitable manner and may be symmetric or asymmetric across a width and/or length of the FSS 905. The grid pattern may comprise sub-wavelength periodic microstructures. A matching dielectric layer 910 may be positioned in front of the FSS 905 and may overlap the FSS 905 in a region associated to the radiating elements 205a, . . . 205h. Feed boards 915 for low band radiation elements may be positioned in front of the FSS 905 in regions not associated with the radiating elements 205a, . . . 205h. In the example shown in FIG. 9, a first pair of outer beam-shaping elements 300a and a second pair of inner beam-shaping elements 300b may be positioned to flank the outer radiating element columns 205a and 205h of the antenna 900 similar to the example described above with respect to FIGS. 4A-4D. A radome 920 may be used to enclose the various components of the antenna 900 to protect the components from the environment. The use of the beam-shaping elements 300a and 300b may redirect energy emitted by the radiating elements of the outer columns 205a and 205h that is associated with side lobes of a radiating pattern towards a main lobe of the radiation pattern to increase the half-power beamwidth of the radiation pattern in the azimuth plane. Moreover, the beam-shaping elements 300a and 300b may be configured to modify the radiation pattern output from the radiating elements of the outer columns 205a and 205h in the azimuth plane without modifying the radiation pattern output from the radiating elements in the elevation plane.

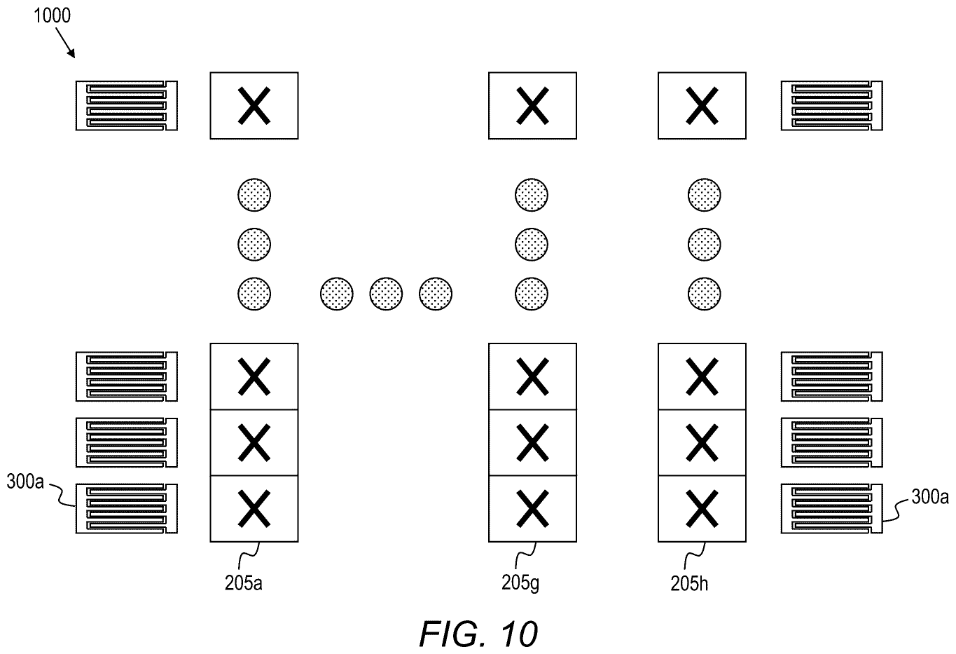

As described above with respect to FIGS. 6A-6D, however, the overlap of the inner beam-shaping elements 300b with inner columns 205b and 205g of the antenna 900 array may reduce the gain of these columns. Referring to FIG. 10, an antenna 1000 is similar to the antenna 900 of FIG. 9, but the antenna 1000 differs from the antenna 900 in that the inner pair of beam-shaping elements 300b may be removed from the example of FIG. 9 while keeping the outer beam-shaping elements 300a, which are positioned on the outside of the first radiating element column 205a and the eighth radiating element column 205h. While the increase in half-power beamwidth for the outer columns 205a and 205h may be reduced relative to that of the FIG. 9 embodiment, the benefit is that there will be less reduction in gain for any of the internal radiating element columns 205b-205g.

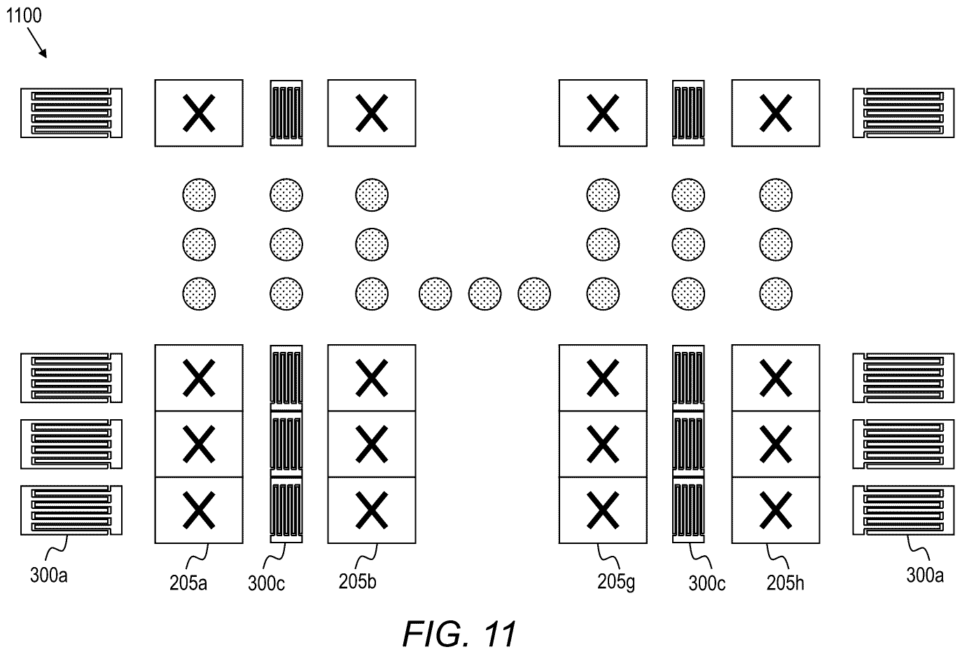

FIG. 11 illustrates an example of an antenna 1100 that is also similar to the antenna 900 of FIG. 9, but the antenna 1100 differs from the antenna 900 in that inner beam-shaping elements 300c are used that are rotated 90 degrees relative to the inner beam-shaping elements 300b. In the example of FIG. 9, the inner beam-shaping elements 300b are oriented so that their fingers 310a and 310b (see, e.g., FIG. 3) extend laterally in the Y direction. In the example of FIG. 11, the inner beam-shaping elements 300c are oriented so that their fingers 310a and 310b extend in the Z direction of FIG. 9 or in a direction parallel to the direction that the radiating element columns 205a-205h extend. By changing the orientation of the inner beam-shaping elements 300c to align with the direction that the radiating elements columns 205a-205h extend, the amount of overlap of the beam-shaping elements 300c with one or more of the inner radiating element columns 205b-205g in the signal transmission direction may be reduced, which may mitigate the reduction in gain for the inner radiating element columns 205b-205g caused by the inner beam-shaping elements 300b.

While embodiments of the present invention have been described above primarily with reference to the accompanying drawings, it will be appreciated that the invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

Herein, the terms “attached,” “connected,” “interconnected,” “contacting,” “mounted” and the like can mean either direct or indirect attachment or contact between elements, unless stated otherwise.

It will also be appreciated that the various embodiments described above may be combined in any and all ways to provide additional embodiments.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A base station antenna comprising:
a radiating element configured to radiate in a first direction; and
a beam-shaping element spaced apart from the radiating element in the first direction and offset from the radiating element in a second direction that is perpendicular to the first direction, such that the radiating element and the beam shaping element do not overlap in the first direction, the beam shaping element including a plurality of interdigitated fingers.

2. The base station antenna of claim 1, further comprising
a plurality of beam-shaping elements spaced apart from the radiating element in the first direction and offset from the radiating element in the second direction that is perpendicular to the first direction, each of the plurality of beam-shaping elements including a plurality of interdigitated fingers, the plurality of beam shaping elements including the beam-shaping element and being arranged on a first side of the radiating element.

3. The base station of claim 2, wherein the plurality of beam-shaping elements is a first plurality of beam-shaping elements, the base station antenna further comprising:
a second plurality of beam-shaping elements spaced apart from the radiating element in the first direction and offset from the radiating element in the second direction that is perpendicular to the first direction, each of the plurality of second beam-shaping elements including a plurality of interdigitated fingers, the second plurality of beam shaping elements being arranged on a second side of the radiating element opposite the first side.

4. The base station antenna of claim 1, further comprising:
a plurality of beam-shaping elements spaced apart from the radiating element in the first direction without overlapping the radiating element in the first direction, each of the plurality of beam-shaping elements including a plurality of interdigitated fingers, the plurality of beam-shaping elements including the beam-shaping element and encircling the radiating element in a plan view.

5. The base station antenna of claim 1, wherein the beam-shaping element comprises opposing first and second end portions each with the plurality of fingers extending therefrom, the plurality of fingers extending from the first end portion being interdigitated with the plurality of fingers extending from the second end portion.

6. The base station antenna of claim 5, wherein the radiating element is configured to radiate at a frequency of 3.4-4.0 GHz;
wherein a length of each of the plurality of fingers of the first and second end portions is less than ½ of a wavelength of a highest frequency; and
wherein the beam-shaping element comprises copper, aluminum, and/or metalized plastic.

7. (canceled)

8. The base station antenna of claim 1, wherein the beam-shaping element is configured to modify a radiation pattern output from the radiating element in a first plane without modifying the radiation pattern output from the radiating element in a second plane.

9. The base station of claim 8, wherein the first plane is an azimuth plane and the second plane is an elevation plane.

10. The base station of claim 9, wherein the beam-shaping element is configured to increase a half-power beamwidth of the radiation pattern output from the radiating element in the azimuth plane.

11. The base station of claim 9, wherein the beam-shaping element is further configured to increase a gain of the radiating element.

12. The base station antenna of claim 1, wherein the beam-shaping element is configured to re-direct radiation power associated with side lobes of a radiation pattern output from the radiating element towards a main lobe of the radiation pattern output from the radiating element.

13. The base station antenna of claim 11, wherein the beam-shaping element is configured to increase a half-power beamwidth of the radiation pattern output from the radiating element in an azimuth plane.

14. A base station antenna comprising:
an antenna array that includes multiple columns of radiating elements and having first and second opposing sides;
a first plurality of beam-shaping elements positioned adjacent the first side; and
a second plurality of beam-shaping elements positioned adjacent the second side;
wherein at least some of the first plurality of beam-shaping elements and the second plurality of beam-shaping elements are configured to redirect RF energy emitted by the antenna array in a first plane without redirecting the RF energy emitted by the antenna array in a second plane.

15. The base station antenna of claim 14, wherein the first plane is an azimuth plane and the second plane is an elevation plane.

16. The base station antenna of claim 14, wherein a first outer column of the multiple columns of radiating elements is adjacent the first side;
wherein the base station antenna further comprises:
a third plurality of beam-shaping elements positioned between the first outer column and one of the multiple columns of radiating elements that is immediately adjacent to the first outer column;
wherein at least some of the third plurality of beam-shaping elements are configured to redirect RF energy emitted by the antenna array in the first plane without redirecting the RF energy emitted by the antenna array in the second plane.

17. The base station antenna of claim 16, wherein each of the first, second, and third pluralities of beam-shaping elements comprises opposing first and second end portions each with a plurality of fingers extending therefrom, the plurality of fingers extending from the first end portion being interdigitated with the plurality of fingers extending from the second end portion.

18. The base station antenna of claim 17, wherein each of the radiating elements is configured to radiate at a frequency of 3.4-3.0 GHz; and
wherein a length of each of the plurality of fingers of the first and second end portions is less than ½ of a wavelength of a highest frequency.

19. The base station antenna of claim 18, wherein each of the beam-shaping elements comprises copper, aluminum, and/or metalized plastic.

20. The base station antenna of claim 17, wherein each of the first plurality of beam-shaping elements has a first orientation relative to the first outer column of the multiple columns of radiating elements; and
wherein each of the third plurality of beam-shaping elements has a second orientation relative to the first outer column of the multiple columns of radiating elements.

21. The base station antenna of claim 20, wherein each of the multiple columns of radiating elements extends in a first direction;
wherein the plurality of fingers of ones of the first plurality of beam-shaping elements extends in a second direction perpendicular to the first direction; and
wherein the plurality of fingers of ones of the third plurality of beam-shaping elements extends in the first direction.

22-31. (canceled)
